(19) United States
(12) Patent Application Publication
(10) Pub. No.: US 2018/0285238 A1
(43) Pub. Date: Oct. 4, 2018

(54) INTELLIGENT DEINSTRUMENTATION OF INSTRUMENTED APPLICATIONS

(71) Applicant: CA, Inc., New York, NY (US)

(72) Inventor: Pradeep Kishore Somesula, Hyderabad (IN)

(21) Appl. No.: 15/474,164

(22) Filed: Mar. 30, 2017

(51) Int. Cl. G06F 11/36; G06F 9/455; G06F 11/30

(52) U.S. Cl. CPC G06F 11/3644; G06F 11/302; G06F 9/4552

(57) ABSTRACT

Intelligently deinstrumenting an executing instrumented application includes the steps of: a) monitoring an executing application; b) identifying at least one portion of the executing application that includes instrumentation; c) automatically determining to remove the instrumentation based on one or more characteristics associated with the at least one portion of the executing application; and d) removing the instrumentation associated with the at least one portion of the executing application.

### BACKGROUND

There is an ever-increasing presence of many new applications in e-commerce, education and other areas deployed on computer networks such as the Internet. Organizations increasingly rely on such applications to carry out their business or other objectives, and devote considerable resources to ensuring that the applications perform as expected. To this end, various application management techniques have been developed.

One approach involves monitoring an application, during development and testing, by instrumenting individual software components in the application, and collecting data regarding the instrumented components that are invoked when the application runs. Instrumentation can involve using agents that operate within the system being monitored. For example, instrumentation allows an execution flow, e.g., thread or process, to be traced to identify each component that is invoked as well as obtain runtime data such as the execution time of each component. While instrumenting the software components can be performed manually, instrumenting can also be performed automatically be identifying the individual components and instrumenting each one in various ways.

### BRIEF SUMMARY

One aspect of the present disclosure relates to a computer implemented method that includes the steps of: a) monitoring an executing application; b) identifying at least one portion of the executing application that includes instrumentation; c) automatically determining to remove the instrumentation based on one or more characteristics associated with the at least one portion of the executing application; and d) removing the instrumentation associated with the at least one portion of the executing application.

Another aspect of the present disclosure relates to a system that includes a memory device storing executable code; and a processor in communication with the memory device. Furthermore, the executable code, when executed by the processor, causes the processor to: a) monitor an executing application; b) identify at least one portion of the executing application that includes instrumentation; c) automatically determine to remove the instrumentation based on one or more characteristics associated with the at least one portion of the executing application; and d) remove the instrumentation associated with the at least one portion of the executing application.

Yet another aspect of the present disclosure relates to a non-transitory computer-readable medium having instructions stored thereon that are executable by a computing device to perform operations. Those operations include: a) monitoring an executing application; b) identifying at least one portion of the executing application that includes instrumentation; c) automatically determining to remove the instrumentation based on one or more characteristics associated with the at least one portion of the executing application; and d) removing the instrumentation associated with the at least one portion of the executing application.

### BRIEF DESCRIPTION OF THE DRAWINGS

Aspects of the present disclosure are illustrated by way of example and are not limited by the accompanying figures with like references indicating like elements.

FIG. 1 depicts a block diagram of an example environment in which an instrumented application may be intelligently deinstrumented in accordance with the principles of the present disclosure.

FIG. 2 is a flowchart of an example method of intelligently deinstrumenting an executing instrumented application in accordance with the principles of the present disclosure.

FIG. 3 is a flowchart of additional details for intelligently deinstrumenting an executing instrumented application in accordance with the principles of the present disclosure.

FIG. 4 is a block diagram of a data processing system in accordance with the principles of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or by combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CORaM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as JAVA, SCALA, SMALLTALK, EIFFEL, JADE, EMERALD, C++, CII, VB.NET, PYTHON or the like, conventional procedural programming languages, such as the “C” programming language, VISUAL BASIC, FORTRAN 2003, PERL, COBOL 2002, PHP, ABAP, dynamic programming languages such as PYTHON, RUBY and GROOVY, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Once a JAVA application, for example, has been compiled into bytecodes and provides all the desired functionality, it may be beneficial to determine how efficiently the application will use system resources when it executes. Rather than add additional code that may affect the application and require re-compilation, instrumentation code is written that probes the application while it is executing. In a JAVA virtual machine environment, an agent is loaded to monitor the application that is also executing in that JAVA virtual machine. The agent monitors when the application makes certain method calls and then the agent executes appropriate portions of the instrumentation code to collect data. The data can relate to performance characteristics such as how often data is being written to a disk, how often a response is sent over a network connection, how much memory is being reserved, how much memory is being released, etc. Within this framework, tools have been created that automatically generate the instrumentation code for a compiled application. By applying automatic rules, a module can analyze the compiled application and automatically generate instrumentation for every method call that matches predetermined criteria. However, as one example, automatic instrumentation may result in all the methods of an Enterprise Java Bean (EJB) or a Bean being instrumented because there may not be any contract methods that are relevant for monitoring. This may result in instrumentation of trivial methods like getters and setters. Automatic generation of instrumentation code is beneficial because it simplifies the process of instrumenting an application, but it has drawbacks in that the resulting instrumentation may be more than is needed to adequately monitor the application.

In particular, application deployment can involve multiple stages or environments such as development, testing, acceptance and production. Once an application is deployed into its production environment, operation and use in the real-world can identify the instrumentation that may be more than is needed to adequately monitor the operating characteristics of the application. Thus, a method for intelligent deinstrumentation is proposed that automatically removes some or all of the instrumentation code that may not be as helpful as other portions of the instrumentation code. In particular, the method includes monitoring, by a computer, an executing application; identifying a portion of the executing application that includes instrumentation; and automatically determining to remove the instrumentation based on one or more characteristics associated with that portion of the executing application. The method finishes by automatically removing the instrumentation associated with the at least one portion of the executing application.

Portions of the executing application that can be deinstrumented in this manner can be identified, for example, by a) determining that an average response time for the portion of the executing application is below a predetermined threshold, b) determining that the portion of the executing application is neither a transaction front-end or an automatically detected entry point of a transaction, c) determining that the portion of the executing application is not a defined back-end, or d) determining whether the name of the method matches a predetermined pattern.

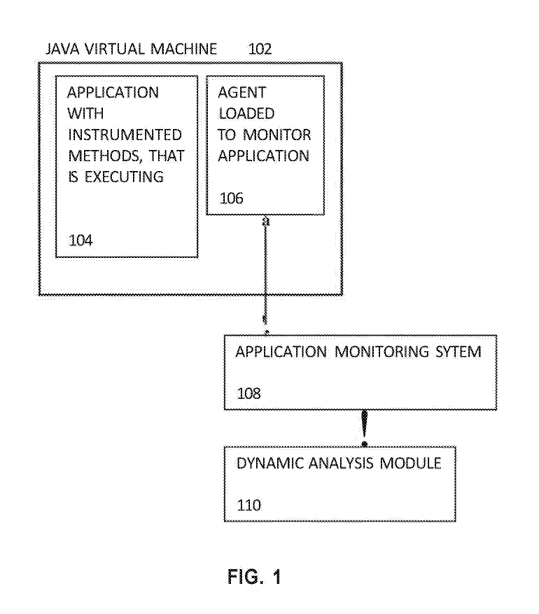

FIG. 1 depicts a block diagram of an example environment in which an instrumented application may be intelligently deinstrumented in accordance with the principles of the present disclosure. An application server can provide an environment in which the JAVA virtual machine (JVM) 102 can execute. Within the JVM 102 an instrumented application 104 is executing, such as, for example, a deployed application in a production environment. There is also an agent 106 loaded in the JVM 102 that monitors the executing application 104. As explained below, due to the interaction between the agent 106 and the instrumented application 104, the agent 106 can communicate information about the application's operation to an application monitoring system 108.

Not shown in FIG. 1 are one or more client machines that communicate via network connections with the application server (or other network server) on which the JVM 102 is executing. These client machines make requests that cause the application 104 to perform the necessary steps to provide a response to the clients.

The application 104 can be organized as different software portions or components which are invoked when various execution paths are invoked in response to receipt of the requests. In particular, the application 104 may respond to a request by accessing information, locally and or remotely, as necessary. For example, a portion of the application 104 may access a database to obtain information for responding to a request. Once a response is prepared, another portion of the application can communicate the response to the client via a network such as the Internet. Further, as already noted, instrumentation is provided for various components, or portions, of the application, such as methods, servlets, Java Server Pages (JSPs), Enterprise Java Beans (EJBs), Java Database Connectivity (JDBC) components and .NET components. Behavior of the application 104 can be monitored by instrumenting bytecode or intermediate language (IL) code of the application, by plugging into an exit built into the application or a network server, or by any other monitoring technique. In one possible approach, the application is instrumented by adding probes to the application. The probes may measure specific pieces of information regarding the application without changing the application's business logic. Each probe may be thought of as a switch that is tripped when a respective, associated portion of the application (e.g., a method) is invoked in an execution path. As the application 104 runs, the probes send data to the agent 106. The agent collects the data and sends it the application monitoring system 108.

The instrumentation allows data to be gathered when the components are invoked during execution of the application 104. For example, the component data can include information such as average response time, errors per interval and invocations per interval. Further, the component data can indicate a utilization of resources by the components (e.g., CPU cycles), execution time, variance in execution times, component size, how frequently a component is called by other components, how frequently a component calls other components, how many different components call a given component, whether a component is a “frontier” component (which can include components that are invoked first or last in servicing a request, or which call an application programming interface (API)), how many instances of a component exist simultaneously and whether a component has a high complexity (a component has high complexity, e.g., when it is an entry point into another component, it makes other method calls so it doesn't just do all the work by itself, and/or it is above a certain length threshold).

The component data can be obtained for a single request and/or aggregated over many requests. The agent 106 can include functionality to analyze the collected component data or communicate with additional program logic that provides the analysis capability. For example, the agent 106 can analyze the component data to determine which instrumented components of the application match particular criteria. In addition to, or as an alternative to, performing such analysis itself, the agent 106 can provide the data from the instrumented components, such as for example in the form of an application component data log, to an application monitoring system 108. Additionally, a request log may also be provided by the agent 106 to maintain a record of the requests which are received by the application 104. The requests can be indexed to the component data in the request log.

The application monitoring system 108, which can operate on the same server as the JVM 102 or a different server, can include a number of different facilities which can be used to process the information received from the agent 106. For example, a dynamic analysis module 110 can be implemented (as part of the agent 106 or the application monitoring system 108) that analyzes the component data which is generated dynamically, e.g., when the application runs. The dynamic analysis module 110 can use a number of criteria which are applied to the component data received by the application monitoring system 108. These criteria can include, e.g., one or more threshold values relating to: utilization of resources by the components, execution time, variance in execution times, component size, how frequently a component is called by other components, how frequently a component calls other components, how many different components call a given component, whether a component is a frontier component, how many instances of a component exist simultaneously, whether a component has a high complexity, whether the component has an average response-per-interval metric value above a predetermined threshold, whether a component has an average response time below a predetermined threshold, whether the component is neither a transaction front-end or an automatically detected entry point of a transaction, whether or not the component is a defined back-end, and whether the name of the component matches a predetermined pattern. Thus, some of the criteria can relate to static items (e.g., a method's name, whether it is a defined back-end, etc.) while other criteria can relate to dynamic information that change as the application 104 executes.

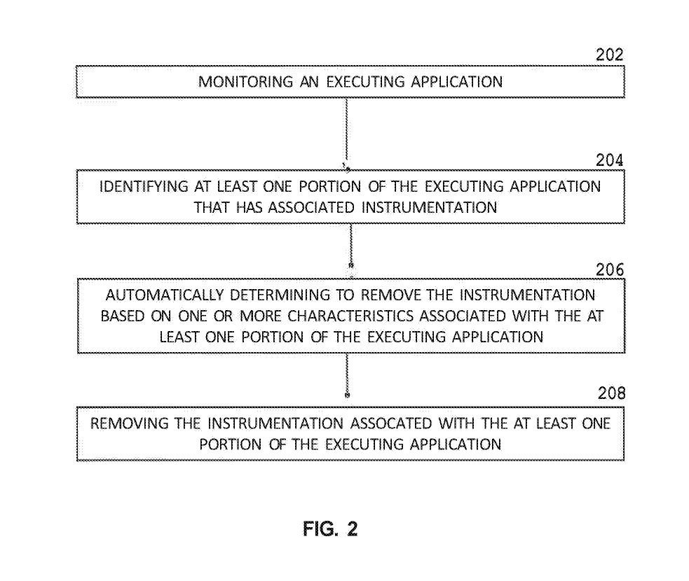

FIG. 2 is a flowchart of an example method of intelligently deinstrumenting an executing instrumented application in accordance with the principles of the present disclosure. With respect to FIG. 1, the flowchart and process of FIG. 2 may be implemented within the agent 106 or the analysis module 110. If performed by the analysis module 110, then that module can communicate with the agent 106 once a determination has been made to deinstrument certain portions of the executing application 104. The method of FIG. 2 begins in step 202 with monitoring an executing application and then, in step 204, identifying at least one portion, or component of the executing application that includes instrumentation.

As explained above, instrumentation such as, for example, probes may be added to the compiled byte-codes of an application (e.g., a managed application) that is executing within the environment of a JVM. A monitoring agent can also be executing within that JVM such that when an execution path of the application invokes an instrumented portion of the application (i.e., a probe is triggered) the agent collects information about that instrumented portion of the application. The information collected by the agent is such that it includes enough details to determine an identification of the probe that is triggered, an identification of the component that is invoked, and one or more operating characteristics of the component.

Accordingly, in step 206, the process continues by automatically determining to remove instrumentation based on one or more characteristics associated with instrumented portions of the application. Thus, the information collected by the agent can be used along with predetermined selection criteria to select instrumentation to remove from the executing application. In the case of selection criteria for static information (e.g., the name of a method matching a particular pattern), the selection criteria can be applied as soon as a matching portion of the application is invoked. For dynamic information, the agent can collect the information over a predetermined time period (e.g., an hour, a day, etc.) and then apply the appropriate selection criteria once the collection period has ended.

Once components, or portions, of the application have been identified that match certain predetermined criteria then their respective, associated instrumentation is removed in step 208. In one example, the instrumentation can be deactivated by turning off the probes for the portion of the application selected for deinstrumentation. In this case, the probes remain in the application but are not active and do not send data to the agent. In another approach, the instrumentation itself, e.g., the probes, can be removed from the application.

Accordingly, if the probes are left in but are merely de-activated, then they may be re-activated at some future time. In this manner, a plurality of different monitoring sessions of the various portions of the executing application can be performed by re-activating probes during different time periods during a day or for different time-intervals. Once operating characteristics of the different portions of the executing application have been collected for multiple sessions, then the selection criteria can be applied to determine which portions of the application should be deinstrumented in a more permanent manner (i.e., removing the probes altogether). Furthermore, a database identifying the instrumentation that was removed can be established in persistent storage. If future execution of the agent occurs to once again evaluate the application for automatic instrumentation, the agent can refer to this persistent database and avoid adding any of the instrumentation identified in the database.

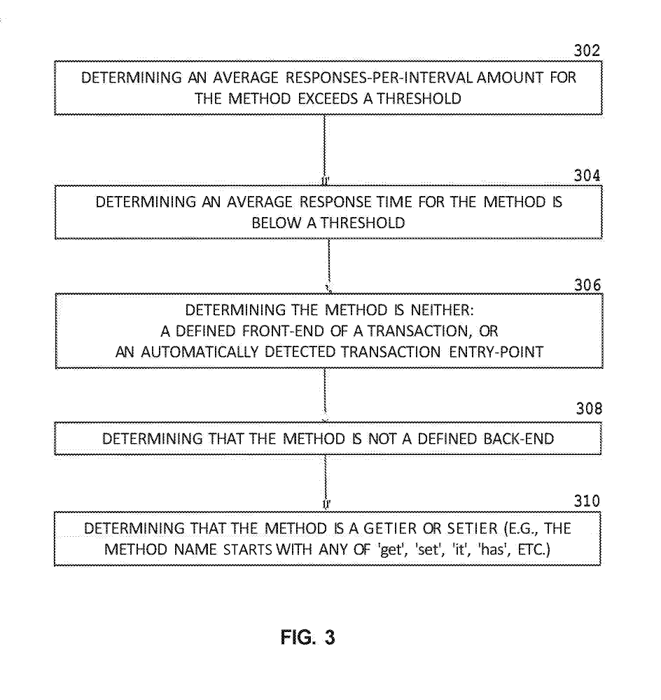

FIG. 3 is a flowchart of additional details for intelligently deinstrumenting an executing instrumented application in accordance with the principles of the present disclosure. In particular, the flowchart of FIG. 3 provides one example of how to perform step 206 in FIG. 2. The selection criteria outlined in the 5 steps of FIG. 3 can be applied in a variety of ways. For example, only if all the criteria are satisfied will a portion of the application be deinstrumented. Alternatively, if any one (or any two) of the criteria are satisfied will a portion of the application be deinstrumented. Another alternative would be if a majority of the criteria were satisfied, then the portion of the application will be deinstrumented. As even a further alternative, if a particular permutation of the criteria is met (e.g., if the criteria of step 302 and step 304 are both satisfied; or if the criteria of step 302 and step 304 are satisfied along with any one of the criteria of steps 306, 308, 310), then the portion of the code will be deinstrumented.

When monitoring of an invoked method reveals that the method has a high value for an average “responses per interval” metric (e.g., 100/sec) and a low value for “average response time” (e.g., 10 ms), the instrumentation associated with this method will increase computer resource utilization (e.g., CPU or processor utilization) as the agent's tracer code is repeatedly executed multiple times. Thus, in step 302, the average “responses per interval” value for the method is determined based on the component data collected by the monitoring agent for this method and compared to the predetermined threshold to determine if the measured value exceeds that threshold. The threshold can be an objective value such as 10/sec or 100/sec or 1000/sec.

In step 304, the “average response time” value for the method is determined based on the component data collected by the monitoring agent for this method and compared to the predetermined threshold to determine if the measured value is below that threshold. The threshold can be an objective value such as 1 ms or 2 ms or 3 ms.

Any method, or portion or component of the executing application, that satisfies both steps 302 and 304 may be identified as portions of the executing application with instrumentation that should be removed.

In step 306, a determination is made as to whether or not the monitored method is a defined front-end of a transaction or an automatically detected entry point of a transaction. When instrumenting of the application originally occurred some methods, or components, could have been explicitly identified as a front-end of a transaction or automatically detected as being and entry point of the transaction. If this is the case, those methods often provide very useful information through instrumentation. Thus, for selecting methods to be deinstrumented, only those methods that are not a defined front-end or a detected entry-point of a transaction are potential candidates for desinstrumentation. For purposes of the present patent application, a transaction is considered to be a logical group of related methods or components that perform functions in a general order relative to one another and, thus, the entry point is the method that is called at a start of the transaction. Typically, a transaction defines a logical unit of work that either completely succeeds or produces no result at all.

In step 308, a determination is made as to whether or not the monitored method is a defined back-end of a transaction. When instrumenting of the application originally occurred some methods, or components, could have been explicitly identified as a back-end of a transaction. If this is the case, those methods often provide very useful information through instrumentation. Thus, for selecting methods to be deinstrumented, only those methods that are not a defined back-end of a transaction are potential candidates for desinstrumentation. For purposes of the present patent application, a transaction is considered to be a logical group of related methods or components that perform functions in a general order relative to one another and, thus, the back-end is the method that is called at the end, or exit, of the transaction.

One family of methods that typically may be deinstrumented include “getters” and “setters”, for example, in Bean objects. In JAVA, getters and setters are completely ordinary functions. The only thing that makes them getters or setters is convention. A getter for “foo” is called getFoo and the setter is called setFoo. In the case of a boolean, the getter is called isFoo (or hasFoo). They also typically have a specific declaration as shown in this example of a getter and setter for ‘name’:

class Dummy
{

private String name;
public Dummy( ) { }
public Dummy(String name) {

this.name = name;

}
public String getName( ) {

return this.name;

}
public void setName(String name) {

this.name = name;

}

}

Thus, in step 310, static information such as the method's name or identifier is analyzed to determine whether it matches a particular pattern. For example, a determination can be made whether the method's name begins with any of “get”, “set”, “is” or “has”. If so, then this method is likely a getter or setter and can be deinstrumented.

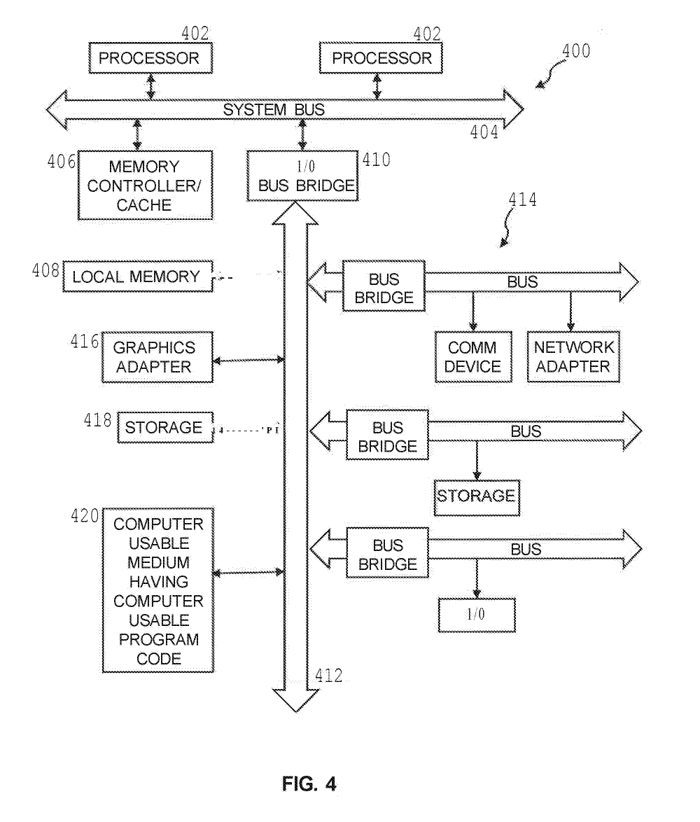

FIG. 4 is a block diagram of a data processing system in accordance with the principles of the present disclosure.

Referring to FIG. 4, a block diagram of a data processing system is depicted in accordance with the present disclosure. A data processing system 400, such as may be utilized to implement the hardware platform 102 or aspects thereof, e.g., as set out in greater detail in FIG. 1-FIG. 3, may comprise a symmetric multiprocessor (SMP) system or other configuration including a plurality of processors 402 connected to system bus 404. Alternatively, a single processor 402 may be employed. Also connected to system bus 404 is memory controller/cache 406, which provides an interface to local memory 408. An I/O bridge 410 is connected to the system bus 404 and provides an interface to an I/O bus 412. The I/O bus may be utilized to support one or more buses and corresponding devices 414, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 416, storage 418 and a computer usable storage medium 420 having computer usable program code embodied thereon. The computer usable program code may be executed to execute any aspect of the present disclosure, for example, to implement aspect of any of the methods, computer program products and/or system components illustrated in FIG. 1-FIG. 3.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A computer implemented method comprising:
monitoring, by a computer, an executing application;
identifying, by the computer, at least one portion of the executing application with associated instrumentation;
automatically determining, by the computer, to remove the associated instrumentation based on one or more characteristics associated with the at least one portion of the executing application; and
removing, by the computer, the associated instrumentation associated with the at least one portion of the executing application.

2. The method of claim 1, wherein the executing application is executing within a JAVA virtual machine.

3. The method of claim 1, wherein the monitoring is performed by an agent, separate from the executing application.

4. The method of claim 3, wherein the one or more characteristics comprise a run-time characteristic that the agent identifies based on the executing application.

5. The method of claim 4, wherein the at least one portion of the executing application comprises a JAVA method.

6. The method of claim 5, wherein the run-time characteristic comprises one or more of: a response per interval amount for the JAVA method, an average response time for the JAVA method, the JAVA method is a getter, or the JAVA method is a setter.

7. The method claim 1, wherein automatically determining to remove the associated instrumentation comprises:
determining, by the computer, that a number of responses per an interval of time, for the at least one portion of the executing application, is above a first predetermined threshold; and
determining, by the computer, that an average response time, for the at least one portion of the executing application, is below a second predetermined threshold.

8. The method of claim 7, wherein automatically determining to remove the associated instrumentation comprises:
determining, by the computer, that the at least one portion of the executing application is neither a transaction front-end or an automatically detected entry point of a transaction.

9. The method claim 8, wherein automatically determining to remove the associated instrumentation comprises:
determining, by the computer, that the at least one portion of the executing application is not a defined back-end.

10. The method claim 9, wherein automatically determining to remove the associated instrumentation comprises:
determining, by the computer, that an identifier associated with the at least one portion of the executing application matches a predetermined pattern.

11. A system comprising:
a memory device storing executable code; and
a processor in communication with the memory device, wherein the executable code, when executed by the processor, causes the processor to:
monitor an executing application;
identify at least one portion of the executing application with associated instrumentation;
automatically determine to remove the associated instrumentation based on one or more characteristics associated with the at least one portion of the executing application; and
remove the associated instrumentation associated with the at least one portion of the executing application.

12. The system of claim 11, wherein the executing application is executing within a JAVA virtual machine.

13. The system of claim 11, wherein the executable code, when executed by the processor, causes the processor to:
execute an agent, separate from the executing application, to monitor the executing application.

14. The system of claim 13, wherein the one or more characteristics comprise a run-time characteristic that the agent identifies based on the executing application.

15. The system of claim 14, wherein the at least one portion of the executing application comprises a JAVA method.

16. The system of claim 15, wherein the run-time characteristic comprises one or more of:
a response per interval amount for the JAVA method, an average response time for the JAVA method, the JAVA method is a getter, or the JAVA method is a setter.

17. The system of claim 11, wherein the processor when automatically determining to remove the associated instrumentation comprises:
determines that a number of responses per an interval of time, for the at least one portion of the executing application, is above a first predetermined threshold; and
determines that an average response time, for the at least one portion of the executing application, is below a second predetermined threshold.

18. The system of claim 17, wherein the processor when automatically determining to remove the associated instrumentation comprises:
determines that the at least one portion of the executing application is neither a transaction front-end or an automatically detected entry point of a transaction.

19. The system claim 18, wherein the processor when automatically determining to remove the associated instrumentation comprises:
determines that the at least one portion of the executing application is not a defined back-end.

20. A non-transitory computer-readable medium having instructions stored thereon that are executable by a computing device to perform operations comprising:
monitoring an executing application;
identifying at least one portion of the executing application with associated instrumentation;
automatically determining to remove the associated instrumentation based on one or more characteristics associated with the at least one portion of the executing application; and
removing the associated instrumentation associated with the at least one portion of the executing application.
